(19) United States
(12) Patent Application Publication
(10) Pub. No.: US 2003/0221775 A1
(43) Pub. Date: Dec. 4, 2003

(54) Method for producing wood composite products with phenolic resins and borate-treated wood materials

(76) Inventors: Martin Feng, Vancouver (CA); Axel Andersen, Burnaby (CA); Paul Morris, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/157,832

(22) Filed: May 31, 2002

(51) Int. Cl. B32B 31/26

(52) U.S. Cl. 156/307.1; 156/335

(57) ABSTRACT

A method is provided for improving the bond strength and quality between a borate-treated wood material and a phenolic resin in a wood composite product, the method having the steps of bonding the wood material with an adhesive system comprising the resin and an additional base, the base providing a substantial increase in the alkalinity of the adhesive system over that provided by the resin, the increase sufficient to limit the bonding of borate molecules with the phenolic resin molecules to such an extent as to allow a substantially complete cross-linking of the phenolic resin molecules to occur. An adhesive system is also disclosed for use in the production of wood composite products.

### TECHNICAL FIELD

The present invention relates to the production of composite wood products, and in particular to methods of improving bond strength and quality between phenolic type resins and borate-treated wood materials.

### BACKGROUND

There are many types of composite products formed from lignocellulosic or cellulosic material. Some examples include laminated structural lumber (known in the art as “Glulam”), finger jointed lumber, plywood, oriented strand board (“OSB”), laminated veneer lumber (“LVL”), medium density fiberboard (“MDF”), and particleboard. These composite products are generally made by adhering together wood materials such as lumber, veneers, strands, flakes, particles, and fibers with adhesives. Phenolic-type adhesives are commonly used, which include phenol-formaldehyde (PF) resins, phenol-resorcinol-formaldehyde (PRF) resins and resorcinol-formaldehyde (RF) resins.

Wood composite materials are frequently used in environments where they may be exposed to fire and also to biological attacks, such as by mould, termite, beetles, decay, etc. There is continually a need for wood composite products that have improved fire-retardant and/or biological-resistant properties.

Treating wood materials with borate compounds is known to provide resistance to biological attack. Adding borate to wood also provides fire retardant properties if the “load level” of the borate is high enough. Borates have been often used in non-composite wood products to provide such fire-resistance and preservative properties. Borates are suitable for such use, since they are considered to have minimal environmental impact and low mammalian toxicity. In fact, borates are known to be used as an antiseptic.

Borate-treated wood material is not typically used to produce wood composite products, however, because the presence of borate compounds severely and negatively affects the bonding between wood materials and phenolic resins.

Borate compounds seem to interact strongly but reversibly with phenolic resin molecules such as those of PF, PRF and RF resins. A small amount of a borate compound can cause dramatic viscosity increase or gellation of a liquid phenolic resin. While it had in the past been suspected that boron atoms somehow increased the polymerization rate of phenolic resins, causing “pre-cure”, it has been recognized by the inventors of the present invention that boron does not cause “precure”, but rather causes “undercure”. It is believed that this phenomenon is most likely due to the formation of co-ordination bonds between boron atoms and phenates. The formation of complex molecules between boron and phenates can then hinder the cross-linking process of a phenolic resin, resulting in poor bond quality.

This is not to say that it has not been long attempted to provide a borate-treated wood composite product. There have been attempts at producing Glulam, for example, from borate-treated wood. Glulam is a structural wood composite product that is commercially produced by bonding lumber with a phenol-resorcinol-formaldehyde resin at ambient temperatures. Borate-treated Glulam would be highly desirable because of its potential termite-resistant and fire-retardant properties. However, bonding borate-treated lumber with a PRF resin at ambient temperatures is difficult and usually results in high glue failure and high delamination of the product after water soaking. Therefore, no successful process of producing borate-treated Glulam with phenolic resin is commercially known, although one would certainly be desirable.

The present invention accordingly provides a method for producing a wood composite product having improved bond quality between typical phenolic resins used in the production of wood composite products and borate-treated wood material.

### SUMMARY OF INVENTION

In its most basic form, the present invention is a method for improving the bond strength and quality between a borate-treated wood material and a phenolic resin. The method comprises the step, in any known method of bonding wood material with a phenolic resin, of adding a base to either the wood material or to the resin itself, thereby increasing the alkalinity of the resin far beyond the common alkalinity range of the resin as it is normally formulated for bonding the same type of wood material without borate.

More specifically, the method provides the step of adding a base, prior to the introduction of the resin to the wood material, to either the wood material itself or to the phenolic resin in an amount sufficient to inhibit the bonding of borate molecules with phenolic resin molecules to such an extent necessary to allow a substantially complete amount of cross-linking of the phenolic resin molecules. The base may be any suitable base but is preferably chosen from the group of sodium hydroxide, sodium carbonate, potassium hydroxide, ammonia, and alkyl amines.

An adhesive system is also provided for use in the production of a wood composite product from borate-treated wood material, the adhesive system having a phenolic resin formulation having an alkalinity percentage, expressed as NaOH%, and a base, wherein the base provides the adhesive system with an alkalinity percentage of more than 50% than that of the resin. In the system, the base may be added either to the resin or to the wood material.

In one embodiment of the invention, a method is provided for producing a wood composite product from a borate-treated wood material and a highly-alkaline adhesive system containing a phenolic resin, the method comprising bonding the wood product together with the adhesive system, wherein the adhesive system comprises a resin formulation and a base added thereto, the base increasing the alkalinity percentage of the phenolic resin by between 50% and 500%. The wood material may be chosen from the group of lumber, veneer, strand, flake, stick, fiber and particle.

In one embodiment of this method, the steps of producing a wood composite product from a borate-treated wood material and a glue mix having a phenolic resin are: (a) adding a base to the glue mix prior to introducing the glue mix to the wood material, thereby increasing the alkalinity percentage of the resin by at least 50%, producing a more highly-alkaline glue mix; (b) applying the more highly-alkaline glue mix to the wood material; (c) placing the wood material in a desired holding assembly; and (d) allowing the phenolic resin to cure; wherein the addition of the base to the glue mix increases the alkalinity percentage of the resin when applied to the wood material by at least 50%.

In another embodiment of this method, the steps of producing a wood composite product from a borate-treated wood material and a glue mix having a phenolic resin are: (a) adding a base to the borate-treated wood material; (b) applying the glue mix to the wood material; (c) placing the wood material in a desired holding assembly; and (d) allowing the phenolic resin to cure; wherein the addition of the base to the borate-treated wood material increases the alkalinity. percentage of the resin when applied to the wood material by at least 50%.

In one embodiment of the invention, the method produces Glulam. In this embodiment, Glulam is produced by bonding borate-treated lumber with an adhesive system containing phenol-resorcinol-formaldehyde resin in which the ratio between alkalinity % (expressed as NaOH %) of the phenol-resorcinol-formaldehyde resin and solids % of the same phenol-resorcinol-formaldehyde resin is between 0.06 and 0.2.

In another embodiment of the invention, the method produces finger jointed lumber. In this embodiment, finger jointed lumber is produced by bonding borate-treated lumber with an adhesive system containing a phenol-resorcinol-formaldehyde resin in which the ratio between alkalinity % (expressed as NaOH %) of the phenol-resorcinol-formaldehyde resin and solids % of the same phenol-resorcinol-formaldehyde resin is between 0.06 and 0.2.

In another embodiment of the invention, the method produces oriented strand board. In this embodiment, oriented strand board is produced by bonding borate-treated wood strands with an adhesive system containing a phenol-formaldehyde face resin in which the ratio between alkalinity % (expressed as NaOH %) of the resin and solids % of the same resin is between 0.12 and 0.4.

In another embodiment of the invention, the method produces oriented strand board. In this embodiment, oriented strand board is produced by bonding borate-treated wood strands with an adhesive system containing a phenol-formaldehyde core resin in which the ratio between alkalinity % (expressed as NaOH %) of the resin and solids % of the same resin is between 0.24 and 0.8.

In another embodiment of the invention, the method produces oriented strand board. In this embodiment, oriented strand board is produced by bonding untreated wood strands with an adhesive system in the presence of a borate compound, wherein the adhesive system contains a phenol-formaldehyde face resin, and the ratio between alkalinity % (expressed as NaOH %) of the resin and solids % of the same resin is more than 0.12.

In another embodiment of the invention, the method produces oriented strand board. In this embodiment, oriented strand board is produced by bonding untreated wood strands with an adhesive system containing a phenol-formaldehyde core resin in the presence of a borate compound, wherein the ratio between alkalinity % (expressed as NaOH %) of the resin and solids % of the same resin is more than 0.24.

In another embodiment of the invention, the method produces plywood. In this embodiment, plywood is produced by bonding borate-treated wood veneers with a glue mix containing a phenol-formaldehyde resin in which the ratio between alkalinity % (expressed as NaOH %) of the resin and solids % of the same resin is between 0.33 and 1.11.

In another embodiment of the invention, the method produces laminated veneer lumber. In this embodiment, laminated veneer lumber is produced by bonding borate-treated wood veneers with a phenol-formaldehyde resin in which the ratio between alkalinity % (expressed as NaOH %) of the resin and solids % of the same resin is between 0.33 and 1.11.

In another embodiment of the invention, the method produces fiberboard. In this embodiment, fiberboard is produced by bonding wood fibers with a phenol-formaldehyde resin in the presence of a borate compound, wherein the ratio between alkalinity % (expressed as NaOH %) of the resin and solids % of the same resin is more than 0.24.

In another embodiment of the invention, the method produces particleboard. In this embodiment, particleboard is produced by bonding wood particles with a phenol-formaldehyde resin in the presence of a borate compound, wherein the ratio between alkalinity % (expressed as NaOH %) of the resin and solids % of the same resin is more than 0.24.

### DESCRIPTION

Throughout the following description, specific details are set forth in order to provide a more thorough understanding of the invention. However, the invention may be practised without these particulars. In other instances, well known elements have not been shown or described in detail to avoid unnecessarily obscuring the invention. Accordingly, the specification is to be regarded in an illustrative, rather than a restrictive, sense.

As described earlier, it is believed by the inventors that borate-treated wood materials do not bond strongly together with one another using typical phenolic resins due to the formation of complex molecules by the boron atoms and phenates. The formation of these complex molecules can then hinder the cross-linking process of the phenolic resin, resulting in poor bond quality. The inventors of the present invention are the first to conceive that adding an excess amount of a water-soluble base to the phenolic resin prior to the application of the resin to a borate-treated wood material would prevent the borate molecules from bonding with the phenolic molecules, or liberate the phenolic resin molecules from the borate molecules by means of substitutions, thereby allowing easier and better cross-linking of the phenolic resin molecules.

Accordingly, the inventors have developed a method for producing wood composite products using this method of improving bond quality between a borate-treated wood material and a phenolic resin by the use of an additional water-soluble base at a high loading level.

In this description of the invention, the term “glue mix” refers to any commonly-known phenolic resin formulation used in the production of wood composite products. As is well known in the art, a glue mix may contain, apart from the resin formulation, other materials such as water, fillers, extenders, catalysts, accelerators, etc.

As is also well known in the art, a large variety of resin formulations and glue mixes are commercially available, and different ones are preferred depending upon the nature of the product to be produced (a different formulation is used to produce OSB than is used to produce plywood, for example). The preferred formulation also depends upon the particular features of the starting wood material (its size and moisture content, for example), and upon the method of application of the glue mix to the wood material (glue mix may be sprayed, curtain coated, roll-spread and applied by foam application equipment, as examples). Some wood composite products use two or more resins or glue mixes in their production; one formulation may be used in the core of the product, for example, and a second formulation used on the face of the product. Such formulations may be supplied “neat”, or in a ready-to-use mixed form.

Most if not all resin formulations, and in turn, glue mixes, are alkaline to some extent, and each formulation has its own range of alkalinity. The common phenolic resins used in the production of OSB, for example, have an alkalinity percentage (expressed as NaOH %) of about between 2-7% of the total resin mass. The phenolic resin commonly used to produce plywood has a higher alkalinity percentage, roughly 10%.

The adhesive system developed by the inventors provides the addition of at least 50% “extra” base to any of such common phenolic resins and resin formulations. It has also been determined that increasing the amount of additional base up to 500% in certain resin formulations can provide favourable results before diminishing returns are seen.

Hereafter the term “adhesive system” means any system in which a water-soluble base is introduced to a known resin formulation, either by adding the base to the formulation itself, or by adding the base to the wood material, either after the wood has been treated with borate, or as part of the borate formulation used to treat the wood. The inventors foresee that any base can be used which might be expected to be capable of nucleophilic attack towards the boron atoms of a borate compound, but in a preferred embodiment of the invention, the base is preferably a water-soluble compound chosen from the group of sodium hydroxide, sodium carbonate, potassium hydroxide, ammonia, and alkyl amines.

In one aspect, the invention provides, accordingly, a method for improving the bond strength and quality between a borate-treated wood material and a phenolic resin in a wood composite product, the method comprising the steps of bonding the wood material with an adhesive system comprising the resin and an additional base, the base providing an increase in the alkalinity of the adhesive system sufficient to limit the bonding of borate molecules with the phenolic resin molecules to such an extent as to allow a substantially complete cross-linking of the phenolic resin molecules to occur. In this description, “substantially complete” cross-linking does not necessarily mean 100% complete cross linking, but rather, “substantially complete” means enough cross-linking of the resin molecules to bond the wood material together to produce a wood composite product that meets certain predetermined product standards known in the art.

Although the method of the present invention finds general application in bonding of borate-treated wood materials with phenolic type resins to make a variety of wood composite products, the following specific example of producing borate-treated Glulam will serve to illustrate the efficiency of the present invention:

### EXAMPLE 1

The method of the present invention can and has been used to produce Glulam containing sodium borate as a termite-resistant agent or a fire-retardant agent. The borate levels on the surface of the lumbers can be as high as 12% boric acid equivalent (BAE %, by mannitol titration). Problems with the normal procedure of producing Glulam from borate-treated wood at ambient temperatures, well known in the art, can be ameliorated by the addition of an amount of sodium hydroxide, premixed with the normal commercial glue mix, which is a commercial phenol-resorcinol-formaldehyde liquid resin and a commercial powder hardener containing paraformaldehyde. For instance, in the case of a commercial PRF resin with 47.6-49.6% non-volatile and 1.55-1.90% alkalinity as NaOH, the amount of sodium hydroxide addition to the glue mix may be 4.0% of the PRF liquid resin weight if the borate level on the treated lumber surface is less than 12% BAE.

When a lamination assembly of six pieces of borate-treated lumber (pine and spruce, 2-7.5% BAE), each lamella measuring 1.5″ thick, 5.5″ wide and 30″ long, was prepared by using such a modified glue mix at a glue spread rate of 36.6 kg/100 m², followed by pressing at 25° C. glueline temperature and under 150 psi pressure for 4.5 hours, the resulting borate-treated Glulam met the requirements of ASTM D-905 and ASTM D-1101 standards while the control made with non-modified glue mix did not. The amount of sodium hydroxide addition can be reduced to 2.0% of the PRF liquid resin weight if at less than 3% BAE (a level above that known to deter termites).

It has been discovered that the effect of the alkaline addition is profound even at ambient temperatures. This is especially important for industrial processes. Spraying an alkaline solution onto the surface of the borate-treated wood material prior to phenolic resin application is also effective.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for improving the bond strength and quality between a borate-treated wood material and a phenolic resin in a wood composite product, the method comprising the steps of bonding the wood material with an adhesive system comprising the resin and an additional base, the base providing an increase in the alkalinity of the adhesive system over that provided by the resin, the increase sufficient to limit the bonding of borate molecules with the phenolic resin molecules to such an extent as to allow a substantially complete cross-linking of the phenolic resin molecules to occur.

2. The method of claim 1 wherein the base is added to the phenolic resin before application of the resin to the wood material, thereby increasing the alkalinity percentage of the resin, expressed as NaOH%, by more than 50%.

3. The method of claim 1 wherein the base is added to the wood material before application of the resin to the wood, thereby increasing the alkalinity percentage of the resin, expressed as NaOH%, by more than 50%.

4. The method of claim 2 wherein the base is chosen from the group of sodium hydroxide, sodium carbonate, potassium hydroxide, ammonia, and alkyl amines.

5. An adhesive system for use in the production of a wood composite product from borate-treated wood material, the adhesive system comprising a phenolic resin formulation having an alkalinity percentage, expressed as NaOH%, and a base, wherein the base provides the adhesive system with an alkalinity percentage of more than 50% than that of the resin.

6. The adhesive system claimed in claim 5, wherein the base is added to the resin.

7. The adhesive system claimed in claim 5, wherein the base is added to the wood material.

8. The use of the adhesive system claimed in claim 5 in the production of a wood composite product.

9. A method for producing a wood composite product from a borate-treated wood material and a highly-alkaline adhesive system containing a phenolic resin, the method comprising bonding the wood product together with the adhesive system, wherein the adhesive system comprises a resin formulation and a base added thereto, the base increasing the alkalinity percentage of the phenolic resin by between 50% and 500%.

10. A method as claimed in claim 9 wherein the borate-treated wood material is chosen from the group of lumber, veneer, strand, flake, stick, fiber and particle.

11. A wood composite product produced by the method claimed in claim 9.

12. A method for producing a wood composite product from a borate-treated wood material and a glue mix having a phenolic resin, the steps in the method comprising:
(a) adding a base to the glue mix prior to introducing the glue mix to the wood material, thereby increasing the alkalinity percentage of the phenolic resin by at least 50%, producing a more highly-alkaline glue mix;
(b) applying the more highly-alkaline glue mix to the wood material;
(c) placing the wood material in a desired holding assembly;
and
(d) allowing the phenolic resin to cure;
wherein the addition of the base to the glue mix increases the alkalinity percentage of the phenolic resin when applied to the wood material by at least 50%.

13. A method for producing a wood composite product from a borate-treated wood material and a glue mix having a phenolic resin, the steps in the method comprising:
(a) adding a base to the borate treated wood material;
(b) applying the glue mix to the wood material;
(c) placing the wood material in a desired holding assembly; and
(d) allowing the phenolic resin to cure;
wherein the addition of the base to the borate-treated wood material increases the alkalinity percentage of the phenolic resin when applied to the wood material by at least 50%.

14. A method as claimed in claim 9 wherein the wood composite product is Glulam produced by bonding borate-treated lumber with an adhesive system containing a phenol-resorcinol-formaldehyde resin in which the ratio between alkalinity % (expressed as NaOH %) of the phenol-resorcinol-formaldehyde resin and solids % of the same phenol-resorcinol-formaldehyde resin is between 0.06 and 0.2.

15. A method as claimed in claim 9 wherein the wood composite product is finger jointed lumber produced by bonding borate-treated lumber with an adhesive system containing a phenol-resorcinol-formaldehyde resin in which the ratio between alkalinity % (expressed as NaOH %) of the phenol-resorcinol-formaldehyde resin and solids % of the same phenol-resorcinol-formaldehyde resin is between 0.06 and 0.2.

16. A method as claimed in claim 9 wherein the wood composite product is oriented strand board produced by bonding borate-treated wood strands with an adhesive system containing a phenol-formaldehyde face resin in which the ratio between alkalinity % (expressed as NaOH %) of the resin and solids % of the same resin is between 0.12 and 0.4.

17. A method as claimed in claim 9 wherein the wood composite product is oriented strand board produced by bonding borate-treated wood strands with an adhesive system containing a phenol-formaldehyde core resin in which the ratio between alkalinity % (expressed as NaOH %) of the resin and solids % of the same resin is between 0.24 and 0. 8.

18. A method as claimed in claim 9 wherein the wood composite product is oriented strand board produced by bonding untreated wood strands with an adhesive system in the presence of a borate compound, wherein the adhesive system contains a phenol-formaldehyde face resin, and the ratio between alkalinity % (expressed as NaOH %) of the resin and solids % of the same resin is more than 0.12.

19. A method as claimed in claim 9 wherein the wood composite product is oriented strand board produced by bonding untreated wood strands with an adhesive system containing a phenol-formaldehyde core resin in the presence of a borate compound, wherein the ratio between alkalinity % (expressed as NaOH %) of the resin and solids % of the same resin is more than 0.24.

20. A method as claimed in claim 9 wherein the wood composite product is plywood produced by bonding borate-treated wood veneers with a glue mix containing a phenol-formaldehyde resin in which the ratio between alkalinity % (expressed as NaOH %) of the resin and solids % of the same resin is between 0.33 and 1.11.

21. A method as claimed in claim 9 wherein the wood composite product is laminated veneer lumber produced by bonding borate-treated wood veneers with a phenol-formaldehyde resin in which the ratio between alkalinity % (expressed as NaOH %) of the resin and solids % of the same resin is between 0.33 and 1.11.

22. A method as claimed in claim 9 wherein the wood composite product is fiberboard produced by bonding wood fibers with a phenol-formaldehyde resin in the presence of a borate compound, wherein the ratio between alkalinity % (expressed as NaOH %) of the resin and solids % of the same resin is more than 0.24.

23. A method as claimed in claim 9 wherein the wood composite product is particleboard produced by bonding wood particles with a phenol-formaldehyde resin in the presence of a borate compound, wherein the ratio between alkalinity % (expressed as NaOH %) of the resin and solids % of the same resin is more than 0.24.
